(19) United States
(12) Patent Application Publication
(10) Pub. No.: US 2025/0286890 A1
(43) Pub. Date: Sep. 11, 2025

(54) SYSTEM AND METHODS FOR HARDWARE-BASED CROSS-DOMAIN MICRO-SEGMENTATION

(71) Applicant: MetalSoft Cloud, Inc., Chicago, IL (US)

(72) Inventors: Lucas Joon Roh, Chicago, IL (US); Alex Bordei, Dobroesti (RO)

(73) Assignee: MetalSoft Cloud, Inc., Chicago, IL (US)

(21) Appl. No.: 19/072,080

(22) Filed: Mar. 6, 2025

Related U.S. Application Data
(60) Provisional application No. 63/563,544, filed on Mar. 11, 2024.

(51) Int. Cl. H04L 9/40

(52) U.S. Cl. CPC H04L 63/101; H04L 63/0227; H04L 63/029

(57) ABSTRACT

A computer network includes: a plurality of hierarchically interconnected nodes that include virtual machines, physical bare metal hosts and container namespaces, wherein the plurality of hierarchically interconnected nodes implement applications across a virtual network domain, a physical network domain and a container network domain; and a single controller configured to provide unified policy application to the plurality of hierarchically interconnected nodes across the virtual network domain, the physical network domain and the container network domain.

### CROSS-REFERENCE TO RELATED APPLICATIONS

The present U.S. Utility Patent Application claims priority pursuant to 35 U.S.C. § 119 (e) to U.S. Provisional Application No. 63/563,544, entitled “SYSTEM AND METHODS FOR HARDWARE-BASED CROSS-DOMAIN MICRO-SEGMENTATION”, filed Mar. 11, 2024, which is hereby incorporated herein by reference in its entirety and made part of the present U.S. Utility Patent Application for all purposes.

### BACKGROUND

### Technical Field

This disclosure relates generally to data centers, computer networks and control systems and methods for use therewith.

### BRIEF DESCRIPTION OF THE SEVERAL VIEWS OF THE DRAWING(S)

FIG. 1A presents a schematic block diagram representation of an example network;

FIG. 1B presents a schematic block diagram representation of an example network;

FIG. 1C presents a schematic block diagram representation of a portion of an example network;

FIG. 1D presents a schematic block diagram representation of an example of a controller;

FIG. 1E presents a flow diagram of an example method;

FIGS. 2A through 2E are schematic block diagrams of embodiments of computing entities that are part of an improved computer technology;

FIGS. 2F through 2L are schematic block diagrams of embodiments of computing devices that form at least a portion of a computing entity; and

FIG. 2M is a schematic block diagram of an embodiment of a database.

### DETAILED DESCRIPTION

Micro-segmentation is essential in reducing the blast radius of security incidents. It allows the administrator of a network to lock down specific application's domain on L2 (Layer 2) and to apply firewall rules between network elements within an L2 domain and potentially other forms of protection such as L7 signature-based filtering.

Earlier systems present the use of micro-segmentation only within the context of virtualized networks or in the context of the physical networks but not both. This leads to a lack of interoperability between the two domains, typically due to the use of two different software defined network (SDN) controllers: one for the physical network and one for the virtual network. However most large companies that operate their own datacenters have applications spread across domains and need to protect the networks that interconnect virtual machines, physical bare metal hosts and container namespaces. This disclosure improves upon the technology of computer network security and control by presenting an approach to segmentation that uses a single controller that is aware of the physical, virtual and container networks and allows unified policy application across all three domains.

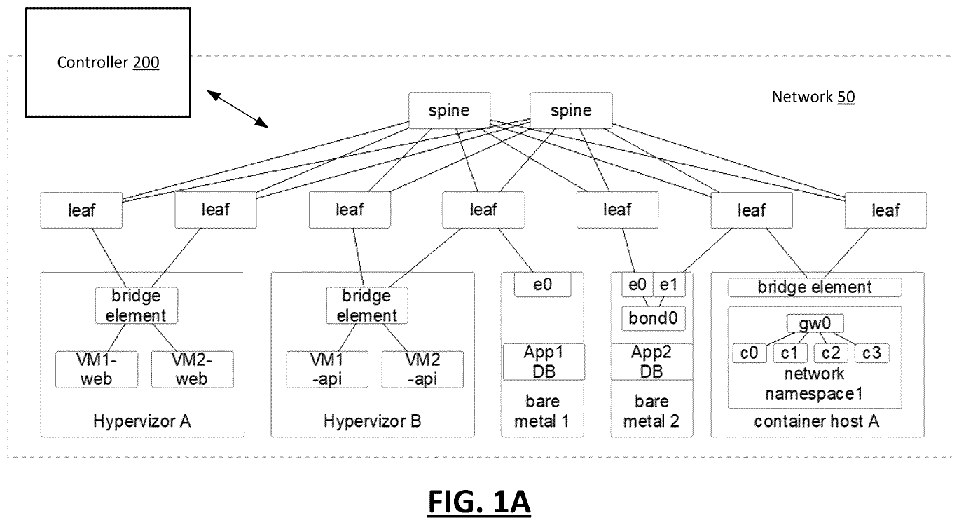

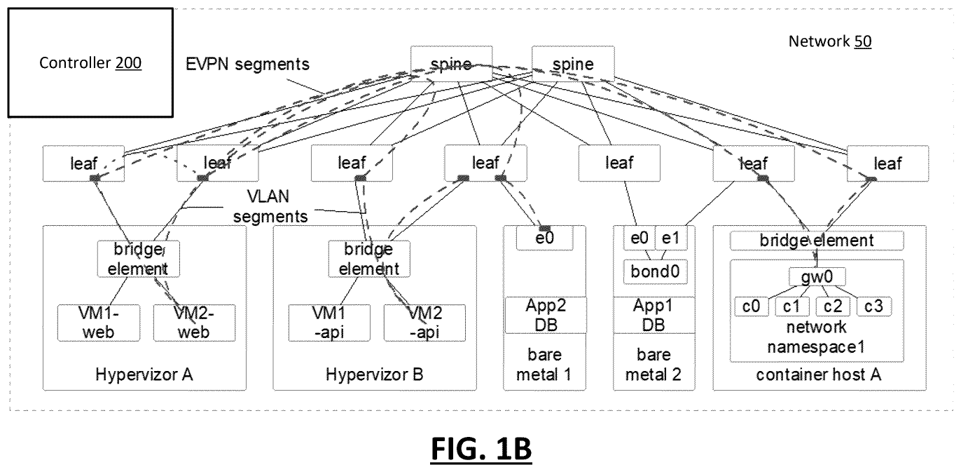

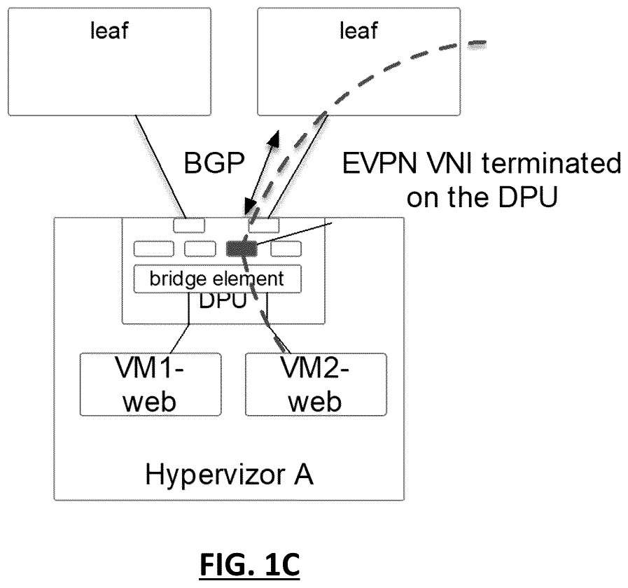

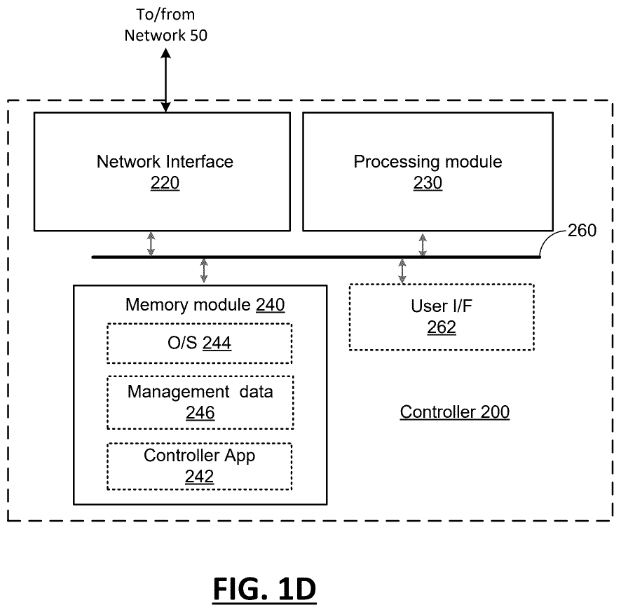

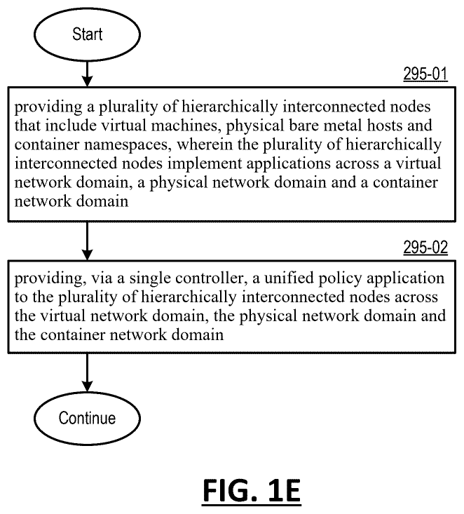

FIG. 1A presents a schematic block diagram representation of an example network 50. In the above diagram the same network interconnects hypervisors running virtual machines (VM) with bare metal hosts and containers. Two applications are described here:
App1 comprising of: VM1-web, VM1-app and App1-db (bare metal)
App2 comprising of: VM2-web, VM2-app, App2-db (bare metal), containers c0,c1,c2,c3,c4

In earlier systems, a hand-over of the traffic between the three domains is accomplished under the control of three different controllers (each specific to their own domain). In this disclosure, a single controller 200 and primarily the hardware layer are used to perform most of the micro-segmentation by creating L2 segments with Ethernet virtual private network (EVPN) or another segmentation technology that, for example, are terminated on the leaf switch ports towards the physical machines from which are handled differently depending on the domain but still under the coordination of the central controller.

The switch ports (or port channels) can be configured to convert virtual network identifier (VNI) IDs to trunk virtual local area network (VLAN) (802.1q) IDs (e.g., hardware VTEP or virtual extensible local area network (VxLAN) tunnel end point). ACL (access control list)/firewall rules are applied on the segment in application specific integrated circuits (ASICs) and then the traffic is forwarded to the hosts. The switch port can be configured to only allow traffic from the respective VLANs thus the host is restricted to accessing only the respective segments irrespective of the type. This protects the wider network 50 from misconfigurations or situations where the host itself is compromised by only allowing certain segments to be accessed.

In various examples, a computer network includes:
a plurality of hierarchically interconnected nodes that include virtual machines, physical bare metal hosts and container namespaces, wherein the plurality of hierarchically interconnected nodes implement applications across a virtual network domain, a physical network domain and a container network domain; and
a single controller configured to provide unified policy application (e.g., such as micro-segmentation) to the plurality of hierarchically interconnected nodes across the virtual network domain, the physical network domain and the container network domain.

In addition or the alternative to any of the foregoing, the plurality of hierarchically interconnected nodes support network traffic across the virtual network domain, the physical network domain and the container network domain.

In addition or the alternative to any of the foregoing, the hierarchically interconnected nodes in the virtual network domain include hypervisor hosts each running a plurality of virtual machines (VMs).

In addition or the alternative to any of the foregoing, each of the hypervisor hosts include a hypervisor bridge element configured to forward portions of the network traffic to the plurality of VMs.

In addition or the alternative to any of the foregoing, the hypervisor bridge element applies an access control list (ACL) or firewall rules.

In addition or the alternative to any of the foregoing, the hypervisor bridge element utilizes hardware accelerated filtering.

In addition or the alternative to any of the foregoing, the hierarchically interconnected nodes in the virtual network domain include bare metal hosts.

In addition or the alternative to any of the foregoing, the network traffic can be sent to the bare metal hosts via an access mode without utilizing a virtual local area network tag.

In addition or the alternative to any of the foregoing, the hierarchically interconnected nodes in the virtual network domain include container hosts.

In addition or the alternative to any of the foregoing, each of the container hosts includes a container bridge element configured to forward, based on an access control list, portions of the network traffic to a network namespace.

Further details including example implementations, several optional functions and features, are described in conjunction with FIGS. 1B-1E that follow. FIG. 1B presents a schematic block diagram representation of an example network 50. EVPN traffic is represented by dashed lines colored in red.

On the host side, depending on the type of host the traffic is handled differently:
1. On hypervisor hosts:
   a “bridge element” can forward the traffic to the interface of the virtual machines that are part of the same segment and can also apply ACLs if necessary. The ACL applications can be dependent on whether the are other VMs in the same segment on the same host and on the number of ACLs used in the switch (The switch ACL tables are limited in size thus this mechanism allows an overflow of rules to the software). Note that processing ACL rules in software is typically slow compared with processing them in the switch ASIC hardware. The “bridge element” is software program that has the role of connecting the physical network and virtual machines together. In some embodiments it can be a Linux bridge, a virtual switch, or in other embodiments it can also be a kernel module that uses ePBF or other forms of hardware accelerated filtering and firewall rules application.
2. On bare metal hosts:
   if the host is part of a single segment the traffic can be sent as “access mode” meaning that from the host's perspective there is no VLAN tag thus the IP address can be configured directly on the interface or, in the case of link aggregation on the “bond” interface.
   If the host is part of more than one segment one of the segments can be considered access mode and the rest trunk mode.
3. On container hosts:
   The same “bridge element” software can apply ACLs as on hypervisor hosts and then can forward traffic to a Linux network namespace. In a network namespace an interface can act as a gateway for the containers.

This approach has many advantages:
Avoids encapsulation and decapsulation as well as ACL/Firewall filtering overhead on the hosts by moving it primarily on the switch ASICs which can perform these operations at “line rate” speed thus avoiding additional latency and higher CPU consumption on the host.
Lower administrative overhead. By using a single controller and defining the polices only once, in a single system they can be applied across all domains at the same time.
Improved security in case of compromised hosts. A compromised host (for example by escaping a VM or container containment mechanism) cannot access segments outside of the segments that the host is allowed to access.
It supports relatively simple implementation on the host with implications on stability.
It uses standard and widely used protocols on the switch side (EVPN-VXLAN) and on the host side (VLAN) allowing reliable interoperability with all hypervisors and container platforms as well as multiple vendors on the switch side as well as an easier maintenance and evolution of the technologies.
It supports latency sensitive workloads such as high frequency trading, storage networks, AI infrastructures and other workloads that are typically not segmented due to performance degradation.

In another embodiment of the “bridge element” illustrated in FIG. 1C, the software can run on an infrastructure processing unit (IPU)/data processing unit (DPU) unit. In this embodiment, the DPU/IPU unit can act as a leaf switch that resides inside a server, the management of which would not be accessible to the hypervisor. The DPU can be managed by the same central controller via the dedicated management port. The DPU would expose single root I/O virtualization (SR-IOV) ethernet interfaces to the Operation System that are then mapped directly to virtual machines without any switching on the hypervisor. From a performance perspective the advantage of this approach is that it offloads some of the ACL and encapsulation and decapsulation from the leaf switches to another set of dedicated ASICs that have more capacity than the switch ASICs, allowing for more ACL rules and more sophisticated L7 security filtering.

This can also allow larger servers to host more VMs on the same segment which would require either filtering in software in the central processing unit (CPU) or filtering on the ASICs of the switch with the added latency of a roundtrip to and from the switch.

FIG. 1D presents a schematic block diagram representation of an example of a controller. In particular, a controller 200 is presented that includes a network interface 220 such as a 3G, 4G, 5G or other cellular wireless transceiver, a Bluetooth transceiver, a WiFi transceiver, UltraWideBand transceiver, WIMAX transceiver, ZigBee transceiver or other wireless interface, a Universal Serial Bus (USB) interface, an IEEE 1394 Firewire interface, an Ethernet interface or other wired interface and/or other network card or modem for communicating for communicating with a network 50.

The controller 200 also includes a processing module 230 and memory module 240 that stores an operating system (O/S) 244 such as an Apple, Unix, Linux or Microsoft operating system or other operating system, management data 246 associated with the network 50—e.g., any of the monitoring data, control data and/or other data communicated via the network. In particular, the O/S 244 and controller application 242 each include operational instructions that, when executed by the processing module 230, cooperate to configure the processing module into a special purpose device to perform the particular functions of the controller 200 described herein.

The controller 200 also includes a user interface (I/F) 262 such as a display device, touch screen, key pad, touch pad, joy stick, thumb wheel, a mouse, one or more buttons, a speaker, a microphone, an accelerometer, gyroscope or other motion or position sensor, video camera or other interface devices that provide information to a user of the controller 200 (e.g. a network manager or administrator) and that generate data in response to the user's interaction with the controller 200.

The processing module 230 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 240. The memory module 240 can include a hard disc drive or other disc drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 260, other architectures are possible including additional data buses and/or direct connectivity between one or more elements.

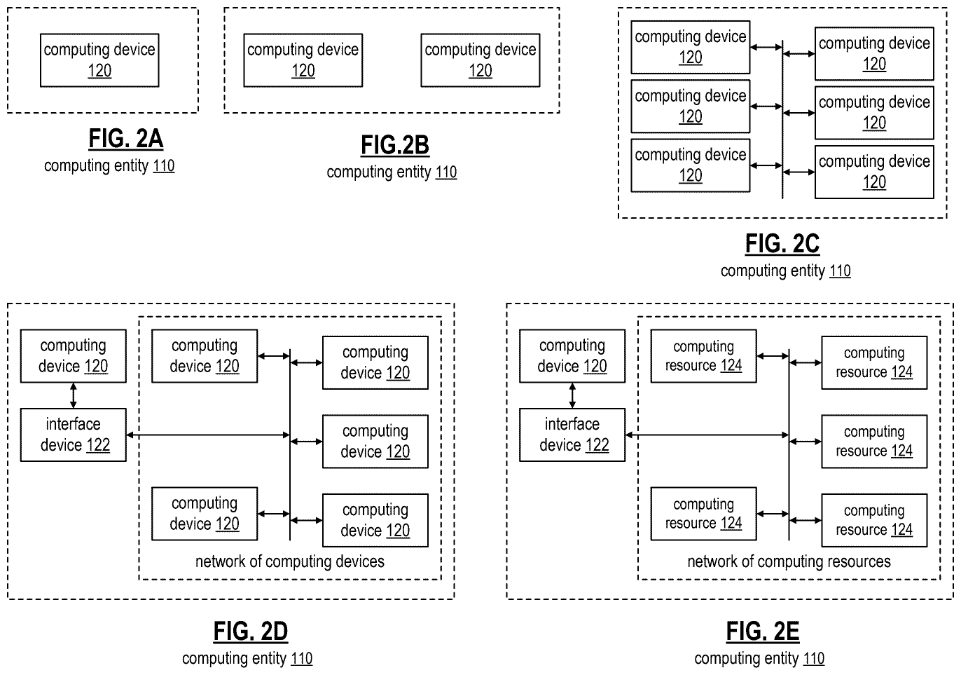

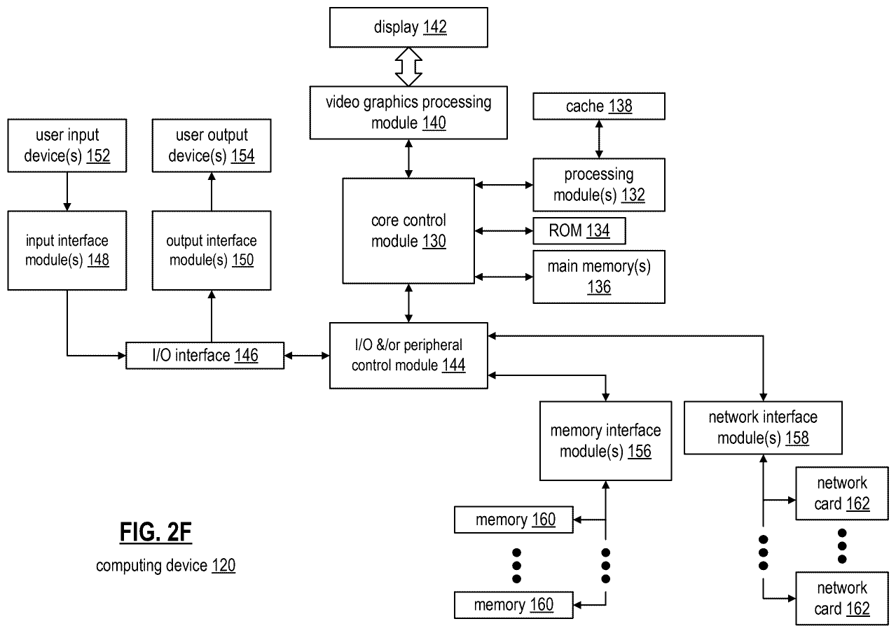

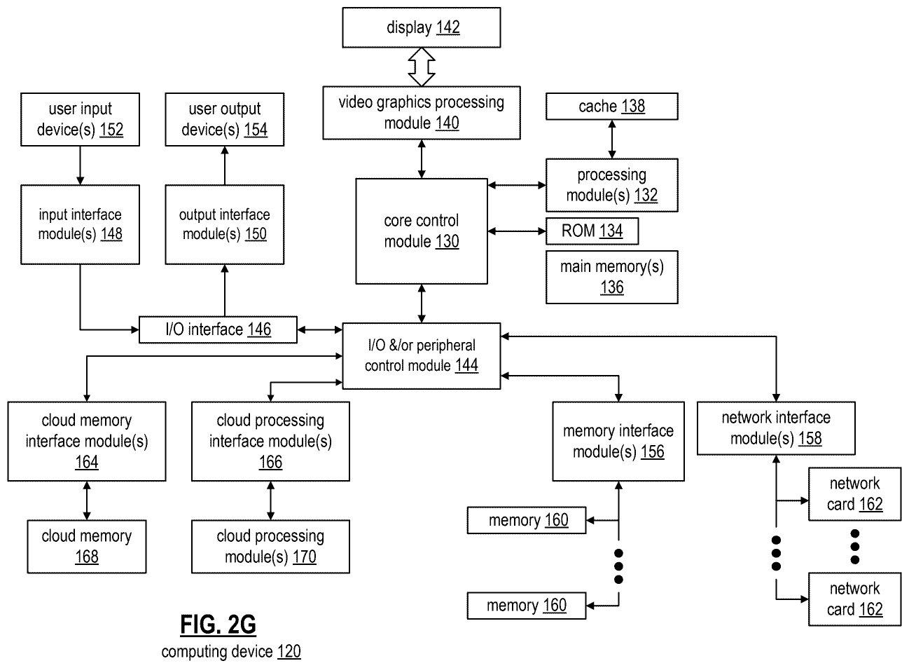

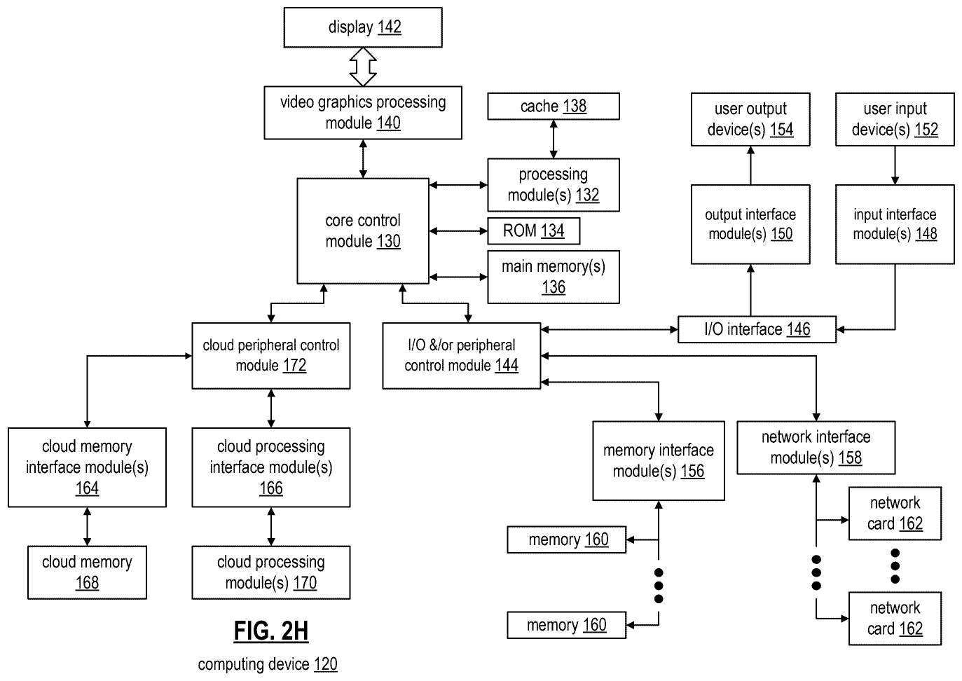

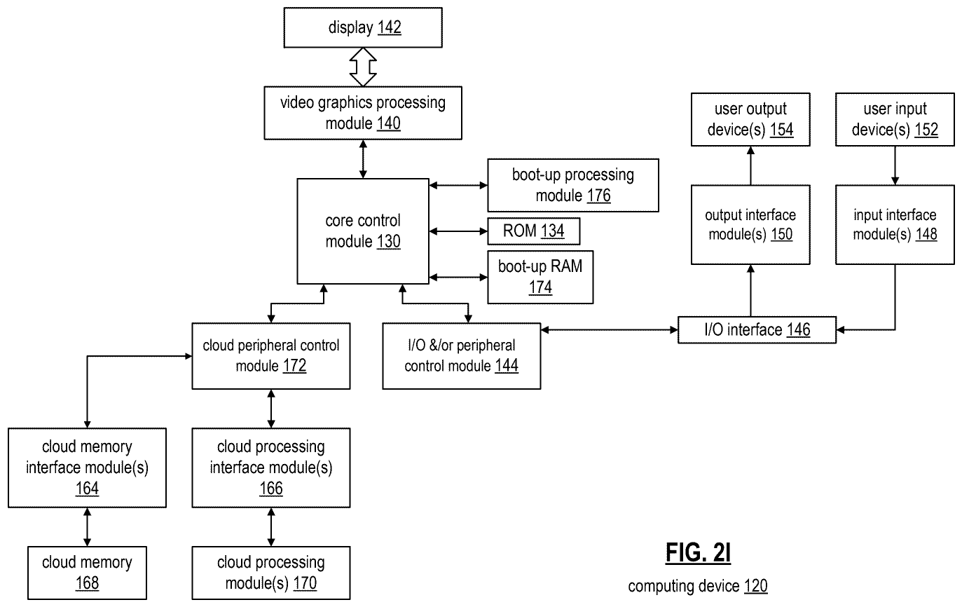

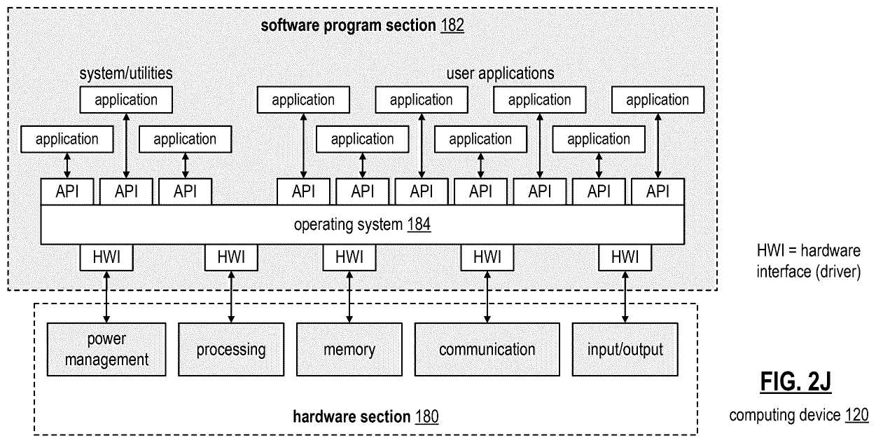

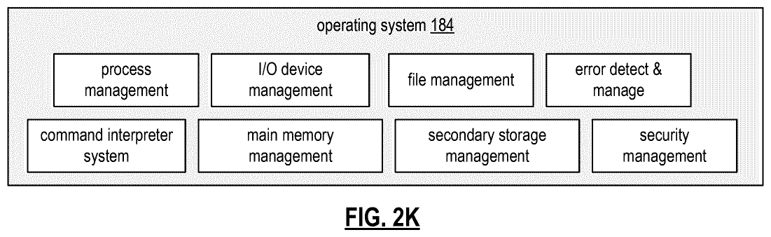

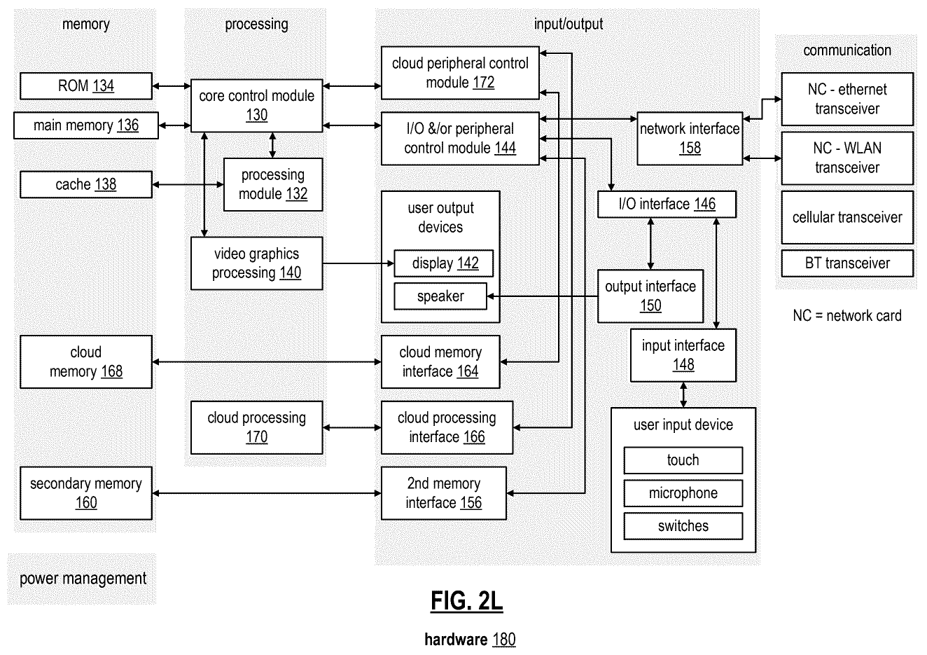

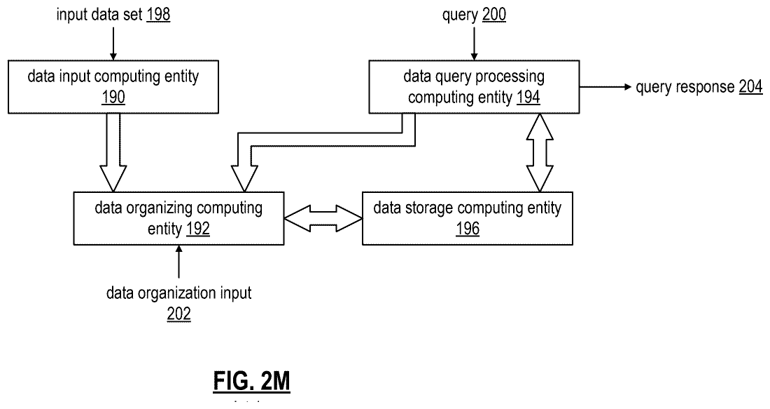

In addition or in the alternative to any of the foregoing, controller 200 (and/or the other components of network 50) can be implemented via computing element 110 described later in conjunction with FIGS. 2A-2M that follow and/or include one or more additional elements that are not specifically shown.

FIG. 1E presents a flow diagram representation of an example of an example method. In particular, a method is presented for use with one or more of the functions and features described in conjunction with any of the other Figures presented herein. Step 295-1 includes providing a plurality of hierarchically interconnected nodes that include virtual machines, physical bare metal hosts and container namespaces, wherein the plurality of hierarchically interconnected nodes implement applications across a virtual network domain, a physical network domain and a container network domain. Step 295-2 includes providing, via a single controller, a unified policy application to the plurality of hierarchically interconnected nodes across the virtual network domain, the physical network domain and the container network domain.

FIG. 2A is schematic block diagram of an embodiment of a computing entity 110 that includes a computing device 120 (e.g., one or more of the embodiments of FIGS. 2F-2L). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 110 that includes two or more computing devices 120 (e.g., two or more from any combination of the embodiments of FIGS. 2F-2L). The computing devices 120 perform the functions of a computing entity in a peer processing manner (e.g., coordinate together to perform the functions), in a master-slave manner (e.g., one computing device coordinates and the other supports it), and/or in another manner.

FIG. 2C is schematic block diagram of an embodiment of a computing entity 110 that includes a network of computing devices 120 (e.g., two or more from any combination of the embodiments of FIGS. 2F-2L). The computing devices are coupled together via one or more network connections (e.g., WAN, LAN, cellular data, WLAN, etc.) and perform the functions of the computing entity.

FIG. 2D is schematic block diagram of an embodiment of a computing entity 110 that includes a primary computing device (e.g., any one of the computing devices of FIGS. 2F-2L), an interface device (e.g., a network connection), and a network of computing devices 120 (e.g., one or more from any combination of the embodiments of FIGS. 2F-2L). The primary computing device utilizes the other computing devices as co-processors to execute one or more of the functions of the computing entity, as storage for data, for other data processing functions, and/or storage purposes.

FIG. 2E is schematic block diagram of an embodiment of a computing entity 110 that includes a primary computing device (e.g., any one of the computing devices of FIGS. 2F-2L), an interface device (e.g., a network connection) 122, and a network of computing resources 124 (e.g., two or more resources from any combination of the embodiments of FIGS. 2F-2L). The primary computing device utilizes the computing resources as co-processors to execute one or more of the functions of the computing entity, as storage for data, for other data processing functions, and/or storage purposes.

FIGS. 2F-2L are schematic block diagram of embodiments of computing devices that form at least a portion of a computing entity. FIG. 2F is a schematic block diagram of an embodiment of a computing device 120 that includes a plurality of computing resources. The computing resources, which form a computing core, include one or more core control modules 130, one or more processing modules 132, one or more main memories 136, a read only memory (ROM) 134 for a boot up sequence, cache memory 138, one or more video graphics processing modules 140, one or more displays 142 (optional), an Input-Output (I/O) peripheral control module 144, an I/O interface module 146 (which could be omitted if direct connect IO is implemented), one or more input interface modules 148, one or more output interface modules 150, one or more network interface modules 158, and one or more memory interface modules 156.

A processing module 132 is described in greater detail at the end of the detailed description section and, in an alternative embodiment, has a direction connection to the main memory 136. In an alternate embodiment, the core control module 130 and the I/O and/or peripheral control module 144 are one module, such as a chipset, a quick path interconnect (QPI), and/or an ultra-path interconnect (UPI).

The processing module 132, the core module 130, and/or the video graphics processing module 140 form a processing core for the improved computer. Additional combinations of processing modules 132, core modules 130, and/or video graphics processing modules 140 form co-processors for the improved computer for technology. Computing resources 124 of FIG. 2E include one more of the components shown in this Figure and/or in or more of FIGS. 2G through 2L.

Each of the main memories 136 includes one or more Random Access Memory (RAM) integrated circuits, or chips. In general, the main memory 136 stores data and operational instructions most relevant for the processing module 132. For example, the core control module 130 coordinates the transfer of data and/or operational instructions between the main memory 136 and the secondary memory device(s) 160. The data and/or operational instructions retrieved from secondary memory 160 are the data and/or operational instructions requested by the processing module or can most likely be needed by the processing module. When the processing module is done with the data and/or operational instructions in main memory, the core control module 130 coordinates sending updated data to the secondary memory 160 for storage.

The secondary memory 160 includes one or more hard drives, one or more solid state memory chips, and/or one or more other large capacity storage devices that, in comparison to cache memory and main memory devices, is/are relatively inexpensive with respect to cost per amount of data stored. The secondary memory 160 is coupled to the core control module 130 via the I/O and/or peripheral control module 144 and via one or more memory interface modules 156. In an embodiment, the I/O and/or peripheral control module 144 includes one or more Peripheral Component Interface (PCI) buses to which peripheral components connect to the core control module 130. A memory interface module 156 includes a software driver and a hardware connector for coupling a memory device to the I/O and/or peripheral control module 144. For example, a memory interface 156 is in accordance with a Serial Advanced Technology Attachment (SATA) port.

The core control module 130 coordinates data communications between the processing module(s) 132 and network(s) via the I/O and/or peripheral control module 144, the network interface module(s) 158, and one or more network cards 162. A network card 160 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 158 includes a software driver and a hardware connector for coupling the network card to the I/O and/or peripheral control module 144. For example, the network interface module 158 is in accordance with one or more versions of IEEE 802.11, cellular telephone protocols, 10/100/1000 Gigabit LAN protocols, etc.

The core control module 130 coordinates data communications between the processing module(s) 132 and input device(s) 152 via the input interface module(s) 148, the I/O interface 146, and the I/O and/or peripheral control module 144. An input device 152 includes a keypad, a keyboard, control switches, a touchpad, a microphone, a camera, etc. An input interface module 148 includes a software driver and a hardware connector for coupling an input device to the I/O and/or peripheral control module 144. In an embodiment, an input interface module 148 is in accordance with one or more Universal Serial Bus (USB) protocols.

The core control module 130 coordinates data communications between the processing module(s) 132 and output device(s) 154 via the output interface module(s) 150 and the I/O and/or peripheral control module 144. An output device 154 includes a speaker, auxiliary memory, headphones, etc. An output interface module 150 includes a software driver and a hardware connector for coupling an output device to the I/O and/or peripheral control module 144. In an embodiment, an output interface module 150 is in accordance with one or more audio codec protocols.

The processing module 132 communicates directly with a video graphics processing module 140 to display data on the display 142. The display 142 includes an LED (light emitting diode) display, an LCD (liquid crystal display), and/or other type of display technology. The display has a resolution, an aspect ratio, and other features that affect the quality of the display. The video graphics processing module 140 receives data from the processing module 132, processes the data to produce rendered data in accordance with the characteristics of the display, and provides the rendered data to the display 142.

FIG. 2G is a schematic block diagram of an embodiment of a computing device 120 that includes a plurality of computing resources similar to the computing resources of FIG. 2F with the addition of one or more cloud memory interface modules 164, one or more cloud processing interface modules 166, cloud memory 168, and one or more cloud processing modules 170. The cloud memory 168 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 170 is similar to processing module 132 but is remote from the core control module and is accessed via a network.

FIG. 2H is a schematic block diagram of an embodiment of a computing device 120 that includes a plurality of computing resources similar to the computing resources of FIG. 2G with a change in how the cloud memory interface module(s) 164 and the cloud processing interface module(s) 166 are coupled to the core control module 130. In this embodiment, the interface modules 164 and 166 are coupled to a cloud peripheral control module 172 that directly couples to the core control module 130.

FIG. 2I is a schematic block diagram of an embodiment of a computing device 120 that includes a plurality of computing resources, which includes include a core control module 130, a boot up processing module 176, boot up RAM 174, a read only memory (ROM) 134, a one or more video graphics processing modules 140, one or more displays 48 (optional), an Input-Output (I/O) peripheral control module 144, one or more input interface modules 148, one or more output interface modules 150, one or more cloud memory interface modules 164, one or more cloud processing interface modules 166, cloud memory 168, and cloud processing module(s) 170.

In this embodiment, the computing device 120 includes enough processing resources (e.g., module 176, ROM 134, and RAM 174) to boot up. Once booted up, the cloud memory 168 and the cloud processing module(s) 170 function as the computing device's memory (e.g., main and hard drive) and processing module.

FIG. 2J is a schematic block diagram of another embodiment of a computing device 120 that includes a hardware section 180 and a software program section 182. The hardware section 180 includes the hardware functions of power management, processing, memory, communications, and input/output. FIG. 2L illustrates the hardware section 180 in greater detail.

The software program section 182 includes an operating system 184, system and/or utilities applications, and user applications. The software program section further includes APIs and HWIs. APIs (application programming interface) are the interfaces between the system and/or utilities applications and the operating system and the interfaces between the user applications and the operating system 184. HWIs (hardware interface) are the interfaces between the hardware components and the operating system. For some hardware components, the HWI is a software driver. The functions of the operating system 184 are discussed in greater detail with reference to FIG. 2K.

FIG. 2K is a diagram of an example of the functions of the operating system of a computing device 120. In general, the operating system function to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 184 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes
Network fault analysis;
Network maintenance for quality of service;
Network access control among multiple clients; and.
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 2L is a schematic block diagram of the hardware components of the hardware section 180 of a computing device. The memory portion of the hardware section includes the ROM 134, the main memory 136, the cache memory 138, the cloud memory 168, and the secondary memory 160. The processing portion of the hardware section includes the core control module 130, the processing module 132, the video graphics processing module 140, and the cloud processing module 170.

The input/output portion of the hardware section includes the cloud peripheral control module 172, the I/O and/or peripheral control module 144, the network interface module 158, the I/O interface module 146, the output device interface 150, the input device interface 148, the cloud memory interface module 164, the cloud processing interface module 166, and the secondary memory interface module 156. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

FIG. 2M is a schematic block diagram of an embodiment of a database that includes a data input computing entity 190, a data organizing computing entity 192, a data query processing computing entity 194, and a data storage computing entity 196. Each of the computing entities is an implementation in accordance with one or more of the embodiments of FIGS. 2A through 2E.

The data input computing entity 190 is operable to receive an input data set 198. The input data set 198 is a collection of related data that can be represented in a tabular form of columns and rows, and/or other tabular structure. In an example, the columns represent different data elements of data for a particular source and the rows corresponds to the different sources (e.g., employees, licenses, email communications, etc.).

If the data set 198 is in a desired tabular format, the data input computing entity 190 provides the data set to the data organizing computing entity 192. If not, the data input computing entity 190 reformats the data set to put it into the desired tabular format.

The data organizing computing entity 192 organizes the data set 198 in accordance with a data organizing input 202. In an example, the input 202 is regarding a particular query and requests that the data be organized for efficient analysis of the data for the query. In another example, the input 202 instructions the data organizing computing entity 192 to organize the data in a time-based manner. The organized data is provided to the data storage computing entity for storage.

When the data query processing computing entity 194 receives a query 200, it accesses the data storage computing entity 196 regarding a data set for the query. If the data set is stored in a desired format for the query, the data query processing computing entity 194 retrieves the data set and executes the query to produce a query response 204. If the data set is not stored in the desired format, the data query processing computing entity 194 communicates with the data organizing computing entity 192, which re-organizes the data set into the desired format.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network).

Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art can also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A computer network comprising:
a plurality of hierarchically interconnected nodes that include virtual machines, physical bare metal hosts and container namespaces, wherein the plurality of hierarchically interconnected nodes implement applications across a virtual network domain, a physical network domain and a container network domain; and
a single controller configured to provide unified policy application to the plurality of hierarchically interconnected nodes across the virtual network domain, the physical network domain and the container network domain.

2. The computer network of claim 1, wherein the plurality of hierarchically interconnected nodes support network traffic across the virtual network domain, the physical network domain and the container network domain.

3. The computer network of claim 2, wherein the hierarchically interconnected nodes in the virtual network domain include hypervisor hosts each running a plurality of virtual machines (VMs).

4. The computer network of claim 3, wherein each of the hypervisor hosts include a hypervisor bridge element configured to forward portions of the network traffic to the plurality of VMs.

5. The computer network of claim 4, wherein the hypervisor bridge element applies an access control list (ACL) or firewall rules.

6. The computer network of claim 4, wherein the hypervisor bridge element utilizes hardware accelerated filtering.

7. The computer network of claim 2, wherein the hierarchically interconnected nodes in the virtual network domain include bare metal hosts.

8. The computer network of claim 7, wherein the network traffic can be sent to the bare metal hosts via an access mode without utilizing a virtual local area network tag.

9. The computer network of claim 2, wherein the hierarchically interconnected nodes in the virtual network domain include container hosts.

10. The computer network of claim 9, wherein each of the container hosts includes a container bridge element configured to forward, based on an access control list, portions of the network traffic to a network namespace.

11. A method comprising:
providing a plurality of hierarchically interconnected nodes that include virtual machines, physical bare metal hosts and container namespaces, wherein the plurality of hierarchically interconnected nodes implement applications across a virtual network domain, a physical network domain and a container network domain; and
providing, via a single controller, a unified policy application to the plurality of hierarchically interconnected nodes across the virtual network domain, the physical network domain and the container network domain.

12. The method of claim 11, wherein the plurality of hierarchically interconnected nodes support network traffic across the virtual network domain, the physical network domain and the container network domain.

13. The method of claim 12, wherein the hierarchically interconnected nodes in the virtual network domain include hypervisor hosts each running a plurality of virtual machines (VMs).

14. The method of claim 13, wherein each of the hypervisor hosts include a hypervisor bridge element configured to forward portions of the network traffic to the plurality of VMs.

15. The method of claim 14, wherein the hypervisor bridge element applies an access control list (ACL) or firewall rules.

16. The method of claim 14, wherein the hypervisor bridge element utilizes hardware accelerated filtering.

17. The method of claim 12, wherein the hierarchically interconnected nodes in the virtual network domain include bare metal hosts.

18. The method of claim 17, wherein the network traffic can be sent to the bare metal hosts via an access mode without utilizing a virtual local area network tag.

19. The method of claim 12, wherein the hierarchically interconnected nodes in the virtual network domain include container hosts.

20. The method of claim 19, wherein each of the container hosts includes a container bridge element configured to forward, based on an access control list, portions of the network traffic to a network namespace.
